(19) United States
(12) Patent Application Publication
(10) Pub. No.: US 2026/0198432 A1
(43) Pub. Date: Jul. 16, 2026

(54) MODULAR AND MOUNTABLE MOSS POLES

(71) Applicant: Grace Elizabeth Melcher, Austin, TX (US)

(72) Inventor: Grace Elizabeth Melcher, Austin, TX (US)

(21) Appl. No.: 19/450,336

(22) Filed: Jan. 15, 2026

Related U.S. Application Data
(60) Provisional application No. 63/746,247, filed on Jan. 16, 2025.

(51) Int. Cl. A01G 22/30; A01G 9/02; A01G 9/12; A01G 27/00

(52) U.S. Cl. CPC A01G 22/30; A01G 9/021; A01G 9/026; A01G 9/128; A01G 27/006

(57) ABSTRACT

Moss poles including a sheet material. The sheet material defines fold lines, access openings, an anchor member, and an anchor opening. The sheet material is folded about the fold lines into an enclosure with walls surrounding a cavity configured to contain growth media. The access openings provide access to the cavity through the walls for a plant supported on the enclosure. The anchor member extends from a first lateral side of the sheet material. The anchor opening is defined proximal to a second lateral side of the sheet material. The anchor opening receives the anchor member. The anchor member inserts into the anchor opening to cause the anchor member to interlock with the anchor opening. In some examples, the moss pole includes a second sheet material, a water dispenser, and/or a hanger.

### CROSS REFERENCE TO RELATED APPLICATIONS

This application claims priority to copending U.S. Application, Serial No. 63746247, filed on January 16, 2025, which is hereby incorporated by reference for all purposes.

### BACKGROUND

The present disclosure relates generally to moss poles. In particular, modular moss poles configured to mount to walls are described.

Moss poles provide a structure to support live plants and to contain a growth medium from which the live plants extract nutrients. Moss poles are well suited to supporting vining and epiphyte plants. Moss poles typically include a structure and contain a growth medium, such as sphagnum moss, hemp fiber, bark, coco coir, or some other organic material.

Known moss poles are adequate for supporting the growth of live plants, but are not entirely satisfactory. For example, conventional moss poles are typically freestanding structures that must be inserted into plant pots. However, conventional moss poles mounted into plant pots often lack stability and are prone to toppling over.

A drawback of conventional moss poles is that they are not adapted to mount to walls. Mounting moss poles to walls would make them more stable, avoid toppling risks, and would enable aesthetically pleasing interior design options. An ability to mount moss poles to walls would also save space.

Another limitation of conventional moss poles is that they do not retain moisture effectively and quickly dry out. Significantly, conventional moss poles tend to become hydrophobic after drying out. The hydrophobic state usually arises just a few days after watering.

Moss poles in a hydrophobic state are very difficult to rehydrate. To water moss poles in a hydrophobic state effectively, users must either thoroughly spray down the entire plant or water the moss pole in small amounts repeatedly over the course of a day. Spraying down an entire plant in a moss pole creates a mess and requires significant space. Repeatedly watering a moss pole throughout a day is tedious and inconvenient.

Conventional moss poles are generally configured as fixed size, standalone units. The standalone configuration limits the moss poles to a single size, which can become insufficient to adequately support a plant that grows larger on the moss pole. When a fixed size moss pole is no longer large enough to support a plant, one may need to attempt transferring the plant to a larger moss pole or cobble together an accessory support unit near the moss pole. Contending with a fixed size, standalone moss pole that is not large enough for a plant is inconvenient and risks harming the plant.

Thus, there exists a need for novel moss poles that improve upon and advance the design of known moss poles. It would be desirable if a novel moss pole existed that was wall mountable, provided improved stability, retained moisture effectively, and allowed for modular extension as the mounted plant grows. Examples of new and useful moss poles relevant to the needs existing in the field are discussed below.

### SUMMARY

The present disclosure is directed to moss poles including a sheet material. The sheet material defines fold lines, access openings, an anchor member, and an anchor opening.

The sheet material is folded about the fold lines into an enclosure. The enclosure includes walls surrounding a cavity configured to contain growth media.

The access openings provide access to the cavity through the walls. A plant supported on the enclosure utilizes the access openings to access growth media contained in the cavity.

The anchor member extends from a first lateral side of the sheet material. The anchor opening is defined proximal to a second lateral side of the sheet material opposite the first lateral side. The anchor opening is complementarily configured with the anchor member to receive the anchor member.

The anchor opening and the anchor member cooperate to secure the first lateral side and the second lateral side together by the anchor member interlocking with the anchor opening.

In some examples, the moss pole includes a second sheet material, a water dispenser, and/or a hanger.

### BRIEF DESCRIPTION OF THE DRAWINGS

FIG. 1 is a front perspective view of a moss pole with two enclosures selectively connected in a vertical arrangement, the moss pole supporting a plant and containing growth media inside a cavity.

FIG. 2 is a rear perspective view of the moss pole shown in FIG. 1.

FIG. 3 is a top perspective view of the moss pole shown in FIG. 1 depicting a water dispenser selectively disposed in the cavity proximal to a top of the enclosure.

FIG. 4 is a bottom perspective view of the moss pole shown in FIG. 1 configured with a single enclosure and depicting a floor removably secured to walls of the enclosure.

FIG. 5 is a front elevation view of the moss pole shown in FIG. 1 configured with a single enclosure.

FIG. 6 is a side elevation view of the moss pole shown in FIG. 1 configured with a single enclosure.

FIG. 7 is a rear elevation view of the moss pole shown in FIG. 1 configured with a single enclosure.

FIG. 8 is a plan view of a sheet material of the moss pole shown in FIG. 1 in a flat configuration distinct from a folded configuration defining the enclosure.

FIG. 9A is a front perspective view of the water dispenser shown in FIG. 3.

FIG. 9B is a rear perspective view of the water dispenser shown in FIG. 3.

FIG. 10 is a front view of a pattern of access openings suitable for front walls of moss pole enclosures.

FIG. 10B is a front view of an alternative pattern of access openings suitable for front walls of moss pole enclosures.

FIG. 10C is a front view of an alternative pattern of access openings suitable for front walls of moss pole enclosures.

FIG. 10D is a front view of an alternative pattern of access openings suitable for front walls of moss pole enclosures.

FIG. 10E is a front view of an alternative pattern of access openings suitable for front walls of moss pole enclosures.

FIG. 10F is a front view of an alternative pattern of access openings suitable for front walls of moss pole enclosures.

### DETAILED DESCRIPTION

The disclosed moss poles will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various moss poles are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Contextual Details

Ancillary features relevant to the moss poles described herein will first be described to provide context and to aid discussing the moss poles.

### Support Surface

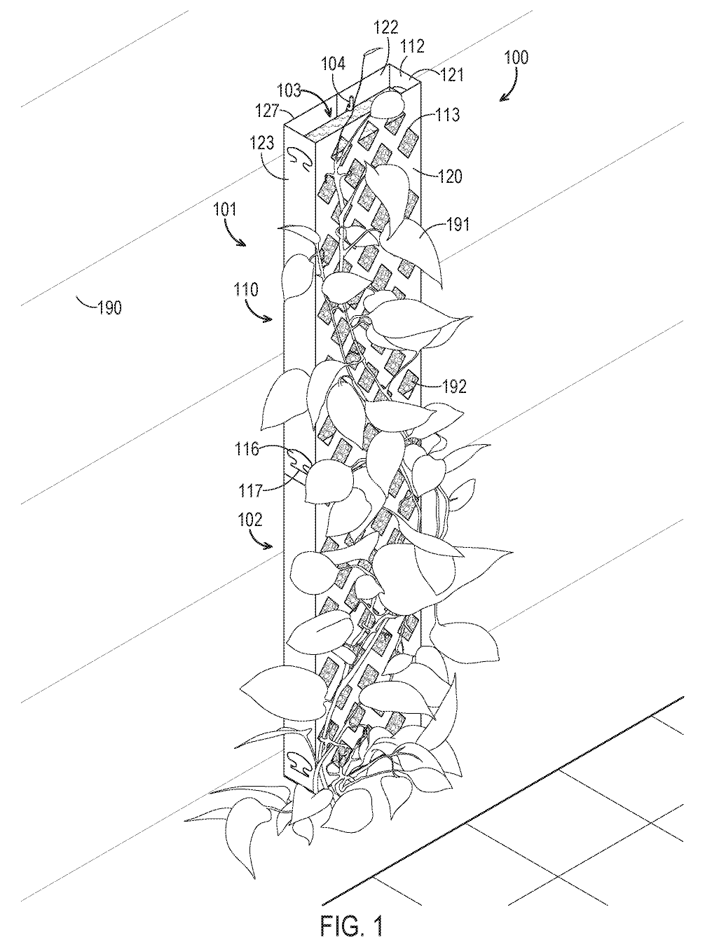

The moss poles described in this document are configured to mount to support surfaces, such as walls or other structures. For example, FIG. 1 shows a moss pole 100 mounted to a support surface 190 in the form of a wall. As explained further below, moss pole 100 hangs from a hanger 104 embedded into wall 190 In other examples, the moss pole hangs from a mechanical fastener, such as a nail or screw, embedded into a wall.

For convenience, this document will primarily refer to walls as the support surface to which the moss poles may mount. However, the reader should understand that the moss poles may mount to any suitably rigid structure capable of receiving fasteners or hangers of some kind. The support surface to which the moss poles may mount include a wall, furniture, a stand, a shelf, or a wide variety of other structures.

### Plants

The moss poles described herein function to support plants. For example, FIG. 1 demonstrates moss pole 100 supporting a plant 191. The moss poles described in this document may support any type of plant suitable for moss pole applications. Vining and epiphyte plants are known to grow well on moss poles.

The moss poles described below may support plants in a wide range of sizes and that climb or spread out to various extents. As described in more detail below, the moss poles are modularly configured and modular moss pole units can be added as needed to accommodate larger plants or plants that climb or spread over longer lengths.

### Growth Media

The moss poles described herein contain growth media supplying nutrients and moisture to plants supported on the moss poles. FIG. 1 shows a growth medium 192 contained within a cavity 112 of an enclosure 110. In the example shown in FIG. 1, growth medium 192 is moss. However, the growth medium may be any currently known or later developed type of growth medium for plants, including sphagnum moss, hemp fiber, bark, coco coir, soil, or other organic material.

### Modular and Mountable Moss Poles

With reference to the figures, modular and mountable moss poles will now be described. The moss poles discussed herein function to support plants and growth media for the plants. The moss poles further function to water the growth media over extended times and prescribed rates facilitating proper plant and growth medium hydration.

The reader will appreciate from the figures and description below that the presently disclosed moss poles address many of the shortcomings of conventional moss poles. The novel moss poles are adapted to mount to walls. Mounting the novel moss poles to walls makes them more stable, avoids toppling risks, and enables aesthetically pleasing interior design options. The novel moss poles save space by mounting to walls as well.

A key benefit of the novel moss poles described herein is that they retain moisture effectively and do not dry out quickly. Significantly, the novel moss poles avoid becoming hydrophobic from quickly drying out like occurs with conventional moss poles.

By more effectively avoiding hydrophobic states, the novel moss poles do not require difficult rehydration undertakings. Beneficially, users of the novel moss poles avoid the need to thoroughly spray down the entire plant and the need to water the moss pole in small amounts repeatedly over the course of a day. By avoiding the need to spray down the entire plant in the novel moss poles, users avoid creating a mess and do not require significant space around the novel moss pole. Further, the novel moss poles dispense with significant tedium and inconvenience by users not needing to repeatedly water the novel moss poles throughout a day.

Beneficially the novel moss poles are modular. The modular design of the novel moss poles enables them to accommodate plants growing larger. When a plant grows larger, the modular nature of the novel moss poles enables them to readily add modular units to increase the size of the moss pole to support the plant. As a result, users of the novel moss poles do not need to attempt transferring the plant to a larger moss pole or need to cobble together an accessory support unit near the moss pole. The modular nature of the novel moss poles enables them to conveniently adapt to the size needed for a growing plant and avoids risks of harming the plant attendant with attempting to transfer a plant to a new moss pole.

In summary, the novel moss poles are desirably wall mountable, provide improved stability, retain moisture effectively, and allow for modular extension as the mounted plant grows.

### Moss Pole Embodiment One

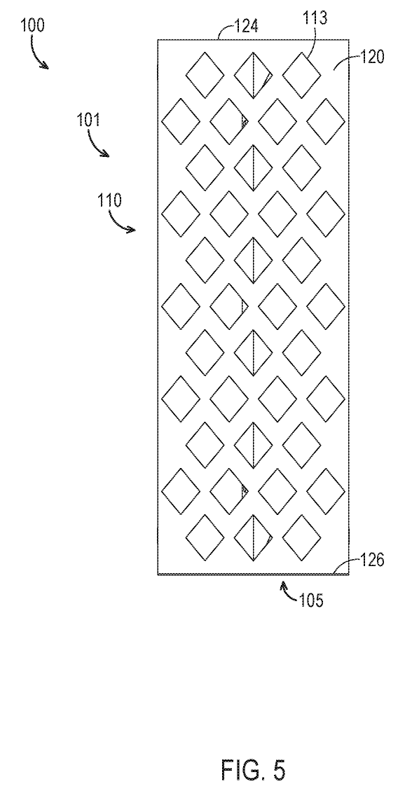

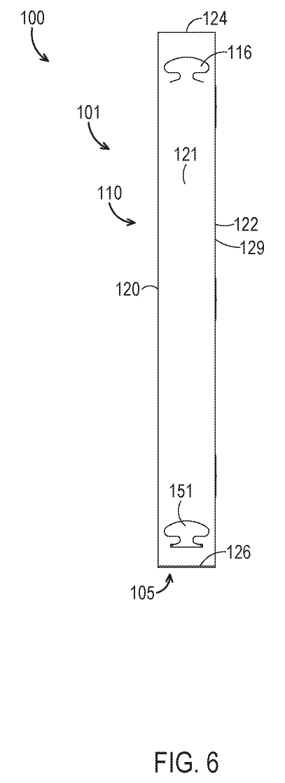

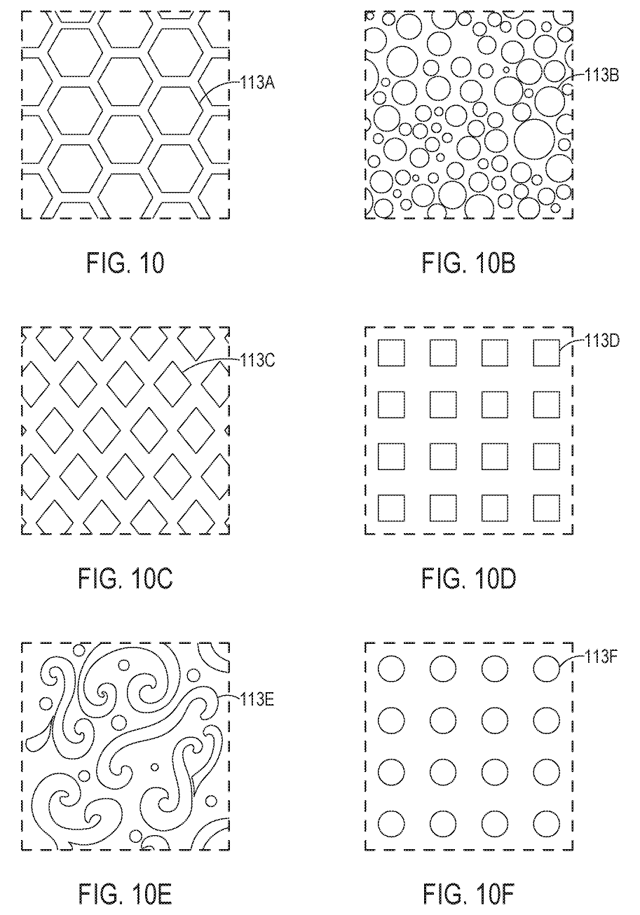

With reference to FIGS. 1-9B, a first example of a moss pole, moss pole 100, will now be described. FIGS. 10-10F show design variations contemplated for the moss poles described herein.

As shown in FIGS. 1-9B, moss pole 100 includes a first sheet material 101, a second sheet material 102, a water dispenser 103, a hanger 104, and a floor member 105. The components of moss pole 100 are discussed in the sections below.

In some examples, the moss pole does not include one or more features included in moss pole 100. For example, some moss pole examples do not include one or more of a second sheet material, a water dispenser, or a hanger. In other examples, the moss pole includes additional or alternative features, such as additional sheet materials or mechanical fasteners.

### Sheet Materials

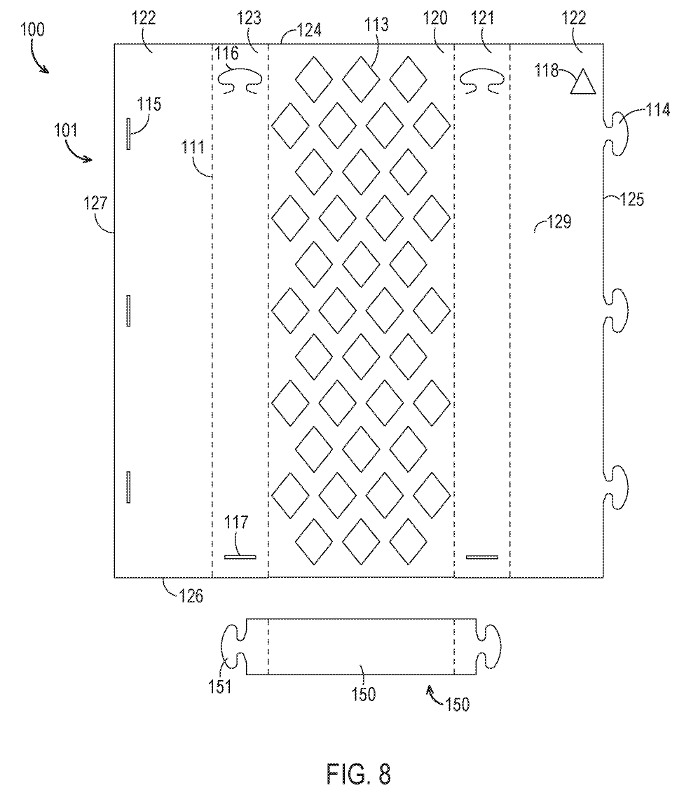

As shown in FIGS. 1-7, sheet material 101 functions to form an enclosure 110 when folded about fold lines 111, which are depicted in FIG. 8 as dashed lines. As demonstrated in FIG. 1, sheet material 101 supports a plant 191 from enclosure 110. Sheet material 101 also serves to contain growth media 192 within a cavity 112 of enclosure 110. Enclosure 110 is effective to retain moisture within cavity 112 and growth media 192 by substantially covering cavity 112 with only relatively small access openings 113 defined in a front wall 120. Access openings 113 allow roots of plant 191 to enter cavity 112 to access growth media 192.

FIG. 1-3 demonstrate that moss pole 100 may include two sheet materials 101 and 102 folded into enclosures. The enclosures are configured to be modular to enable the moss poles to include as many enclosures as needed to accommodate a given plant. The moss poles may include a single enclosure, two enclosures, or a plurality of enclosures.

In the present example, each sheet material 101 and 102 and resulting enclosures are configured identically. Thus, for brevity, the discussion below will describe sheet material 101 in detail and the reader should understand that the same details apply to sheet material 102 (or additional sheet materials when three or more enclosures are included in a moss pole).

With reference to FIG. 8, sheet material 101 defines fold lines 111, access openings 113, anchor members 114, anchor openings 115, connector members 116, connector openings 117, and a mounting opening 118. The components of sheet material 101 are discussed in the subsections below.

With reference to FIG. 8, the reader can see that sheet material 101 is rectangular and includes a top end 124, a first lateral end 125, a bottom end 126, and a second lateral end 127. In other examples, the sheet material is a shape other than rectangular, such as square, triangular, another regular polygon, or an irregular shape.

As shown in FIG. 8, anchor members 114 extend from first lateral end 125 of sheet material 101. With continued reference to FIG. 8, the reader can see that anchor openings 115 are defined proximal to second lateral end 127 of sheet material 101.

The sheet material may be any size suitable for a given moss pole application. Larger and smaller sheet materials resulting in larger and smaller enclosures relative to a plant than depicted in FIG. 1 are contemplated.

In the present example, sheet material 101 comprises plastic. In other examples, the sheet material comprises wood, cardboard, or composite materials. The sheet material may be formed from any currently known or later developed material suitable for forming enclosures and supporting plants.

### Fold Lines

Fold lines 111 facilitate folding sheet material 101 from a two-dimensional shape into a three-dimensional shape; namely, folding sheet material 101 into enclosure 110.

As shown in FIG. 8 with dashed lines, sheet material 101 defines four fold lines 111. However, other sheet material examples may define fewer or additional fold lines. The sheet material may define as many fold lines as needed to facilitate folding the sheet material into a desired enclosure shape.

As demonstrated in FIG. 8, fold lines 111 extend from top end 124 to bottom end 126. In some examples, the sheet material additionally or alternatively defines fold lines extending from the first lateral end to the second lateral end. In certain examples, the sheet material defines fold lines extending diagonally.

The four fold lines 111 defined by sheet material 101 cause enclosure 110 to include four walls; namely, a front wall 120, a first lateral wall 121, a rear wall 122, and a second lateral wall 123. In other configurations, the enclosure defines additional or alternative walls and/or defines enclosures with other shapes.

As shown in FIG. 1, walls 120-123 define cavity 112. Walls 120-123 surround growth medium 192 contained in cavity 112. As depicted in FIGS. 1-4, enclosure 110 defines an enclosure top opening 127 and an enclosure bottom opening 128. Growth media 192 and water dispenser 103 may be placed inside cavity 112 via enclosure top opening 127.

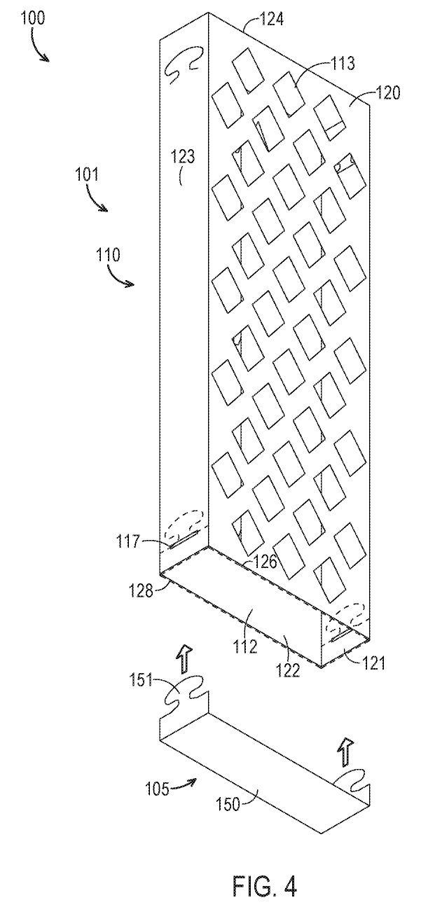

As shown in FIG. 4, floor member 105 is configured to selectively attach to lateral walls 121 and 123 to cover bottom opening 128. Floor member 105 selectively attaches to lateral walls 121 and 123 by inserting floor connector members 151 into connector openings 117 defined in lateral walls 121 and 123. When a user desires to modularly attach a second enclosure to enclosure 110, floor member 105 is selectively removed, the second enclosure defined by second sheet material 102 is connected to sheet material 101 via connector members of second sheet material 102 inserting into connector openings 117 of sheet material 101, and floor member 105 is selectively attached to a bottom opening of the enclosure defined by second sheet material 102.

As shown in FIGS. 1-7, sheet material 101 has a rectangular prismatic shape when folded about fold lines 111 to form enclosure 110. However, the enclosure could be any shape suitable for supporting plants and defining a cavity to contain growth media.

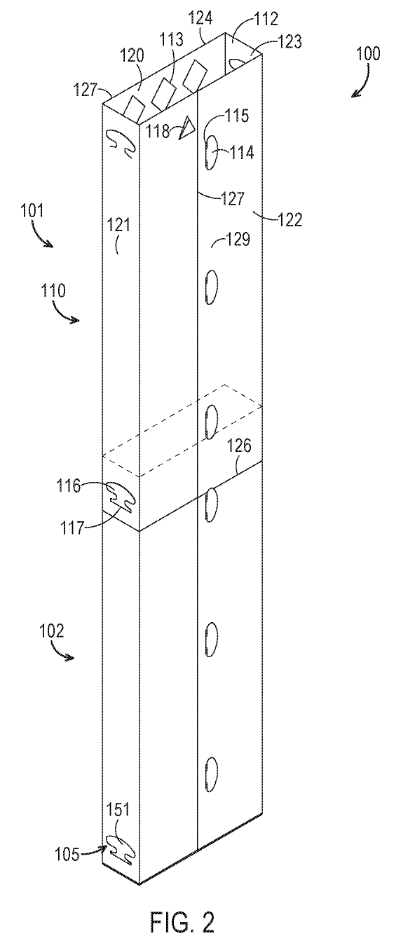

As shown in FIG. 1, rear wall 122 is configured to face support surface 190 when enclosure 120 is selectively mounted to support surface 190. FIGS. 2, 6, and 7 demonstrate that rear wall 122 has a flat outer surface 129 configured to be positioned flat against support surface 190.

As depicted in FIGS. 1, 2, 7, and 8, rear wall 122 defines mounting opening 118. As shown in FIG. 1, hanger 104 may extend through mounting opening 118 to secure enclosure 110 to support surface 190. In the example shown in FIGS. 1, 2, 7 and 8, mounting opening 118 is triangular, but could be any shape suitable for receiving a hanger or other mounting hardware.

As shown in FIG. 1, front wall 120 is spaced from support surface 190 when enclosure 110 is selectively mounted to support surface 190. FIGS. 1-7 demonstrate that front wall 120 is disposed on an opposite side of cavity 112 from rear wall 122. Front wall 120 defines access openings 113 providing access to growth medium 192 contained in cavity 112.

As shown in FIG. 1, first lateral wall 121 and second lateral wall 123 are oriented transverse to a support surface 190 when enclosure 110 is selectively mounted to support surface 190. FIGS. 1-7 demonstrate that second lateral wall 123 is disposed on an opposite side of enclosure 110 than first lateral wall 121.

Lateral walls 121 and 123 define connector members 116 and connector openings 117. As shown in FIGS. 1-4, 6, and 8, connector members 116 are defined proximal to top end 124 of sheet material 101. As further shown in FIGS. 1-4, 6, and 8, connector openings 117 are defined proximal to bottom end 126 of sheet material 101.

### Access Openings

Access openings 113 provide access to cavity 112 through front wall 120. As shown in FIGS. 1, plant 191 supported on enclosure 120 utilizes access openings 113 to access growth media 192 contained within cavity 112.

In the example shown in FIGS. 1-8, access openings 113 are diamond shaped. However, the access openings could be a wide variety of shapes. FIGS. 10-10F demonstrate various suitable shapes and patterns for the access openings.

For example, FIG. 10 depicts honeycomb shaped access openings 113A. In FIG. 10B, bubble shaped access openings 113B are shown. FIG. 10C depicts diamond shaped access openings 113C. In FIG. 10D, square shaped access openings 113D are depicted. FIG. 10E depicts access openings 113E with swirl shapes. In FIG. 10F, circular shaped access openings 113F are shown.

The size and number of access openings 113 is selected to reduce moisture loss within growth medium 192 contained in cavity 112 while concurrently allowing sufficient access for roots of plant 191 to reach growth medium 192. Larger or smaller access openings may be employed in different examples. The collective open area of the access openings is typically selected to balance moisture loss with root access to the cavity.

### Anchor Members

Anchor members 114 are complementarily configured with anchor openings 115 to enable anchor members 114 to insert into anchor openings 115. In particular, anchor members 114 and anchor openings 115 are configured to interlock. Anchor members 114 and anchor openings 115 cooperate to secure first lateral end 125 and second lateral end 127 together by anchor members 114 interlocking with anchor openings 115.

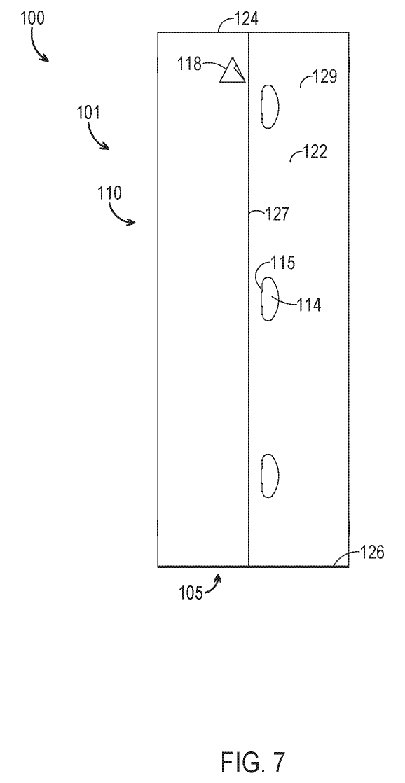

FIG. 8 demonstrates that anchor members 114 extend from first lateral end 125 of sheet material 101 and that anchor openings 115 are defined proximal to second lateral end 127 of sheet material 101. FIGS. 2 and 7 demonstrate that anchor members 114 and anchor openings 115 are disposed on rear wall 122 when sheet material 101 is folded about fold lines 111 to define enclosure 110 and anchor members 114 interlock with anchor openings 115.

In the present example, sheet material 101 defines three anchor members 114, which correlates with the three anchor openings 115 defined by sheet material 101. In other examples, the sheet material defines different numbers of anchor members, such as a single member, two members, or more than three members. The number of anchor members typically corresponds with the number of anchor openings.

The size and shape of the anchor members may vary in different examples. The size and shape of anchor members 114 is selected to restrict anchor members 114 from pulling out of anchor openings 115 unless anchor members 114 are selectively folded. Other size and shape combinations of the anchor members and anchor openings are contemplated.

### Anchor Openings

Anchor openings 115 are complementarily configured with anchor members 114 to receive anchor members 114. In particular, anchor openings 115 and anchor members 114 are configured to interlock. Anchor openings 115 and anchor members 114 cooperate to secure first lateral end 125 and second lateral end 127 together by anchor members 114 interlocking with anchor openings 115. Securing first lateral end 125 and second lateral end 127 together by interlocking anchor members 114 with anchor openings 115 forms rear wall 124.

Anchor openings 115 are defined proximal to second lateral end 127 of sheet material 101. Anchor openings 115 are complementarily configured with anchor members 114 defined at first lateral end 125 of sheet material 101. Inserting anchor members 114 into anchor openings 115 causes anchor members 114 and anchor openings 115 to interlock.

In the present example, sheet material 101 defines three anchor openings 115, which correlates with the three anchor members 114 defined by sheet material 101. In other examples, the sheet material defines different numbers of anchor openings, such as a single opening, two openings, or more than three openings. The number of anchor openings typically corresponds with the number of anchor members.

The size and shape of the anchor openings may vary in different examples. The size and shape of anchor openings 115 is selected to restrict anchor members 114 from pulling out of anchor openings 115 unless anchor members 114 are selectively folded. Other size and shape combinations of the anchor members and anchor openings are contemplated.

### Connector Members

Connector members 116 function to selectively couple together multiple enclosures in cooperation with connector openings 117. As shown in FIGS. 1-3, connector members 116 are complementarily configured with connector openings 117 to enable connector members 116 from second sheet material 102 to interlock with connector openings 117 of first sheet material 101. When connector members 116 from second sheet material 102 interlock with connector openings 117 of first sheet material 101, the enclosures defined by sheet materials 101 and 102 are selectively coupled together.

FIGS. 1-4, 6, and 8 demonstrate that lateral walls 121 and 123 define connector members 116. As shown in FIGS. 1-4, 6, and 8, connector members 116 are defined by lateral walls 121 and 123 proximal to top end 124 of sheet material 101.

In the example shown in FIGS. 1-8, sheet material 101 defines two connector members 116. A first connector is defined on first lateral wall 121 and a second connector is defined on second lateral wall 123. However, the sheet material may define a single connector member or three or more connector members. Typically, the number of connector members matches the number of connector openings defined in the sheet material. In some examples, the sheet material does not define connector members.

### Connector Openings

Connector openings 117 function to selectively couple together multiple enclosures in cooperation with connector members 116. As shown in FIGS. 1-3, connector openings 117 are complementarily configured with connector members 116 to enable connector members 116 from second sheet material 102 to interlock with connector openings 117 of first sheet material 101. As demonstrated in FIGS. 1-3, the enclosures defined by sheet materials 101 and 102 are selectively coupled together when connector members 116 from second sheet material 102 interlock with connector openings 117 of first sheet material 101.

As depicted in FIGS. 1-4, 6, and 8, connector openings 117 are defined in lateral walls 121 and 123. As further shown in FIGS. 1-4, 6, and 8, connector openings 117 are defined by lateral walls 121 and 123 proximal to bottom end 126 of sheet material 101.

In the example shown in FIGS. 1-8, sheet material 101 defines two connector openings 117 with a first connector opening defined on first lateral wall 121 and a second connector opening defined on second lateral wall 123. However, the sheet material may define a single connector opening or three or more connector openings. Typically, the number of connector openings matches the number of connector members defined in the sheet material. In some examples, the sheet material does not define connector openings.

### Mounting Opening

Mounting opening 118 receives hanger 104 or other mounting hardware to selectively mount enclosure 110 to support surface 190. As depicted in FIGS. 1, 2, 7 and 8, mounting opening 118 is defined in rear wall 122 proximal to top end 124. As shown in FIG. 1, hanger 104 may extend through mounting opening 118 to secure enclosure 120 to support surface 190.

In the example shown in FIGS. 1, 2, 7 and 8, mounting opening 118 is triangular. However, the mounting opening could be any shape suitable for receiving a hanger or other mounting hardware.

Sheet material 101 defines a single mounting opening 118. However, the sheet materials may define additional mounting openings in other examples.

### Water Dispenser

Water dispenser 103 functions to dispense water onto growth media 192 at a controlled and distributed rate. Water dispenser 103 is operable to keep growth media 192 adequately hydrated and to avoid moss pole 100 becoming hydrophobic over an extended period of time when periodically filled with water.

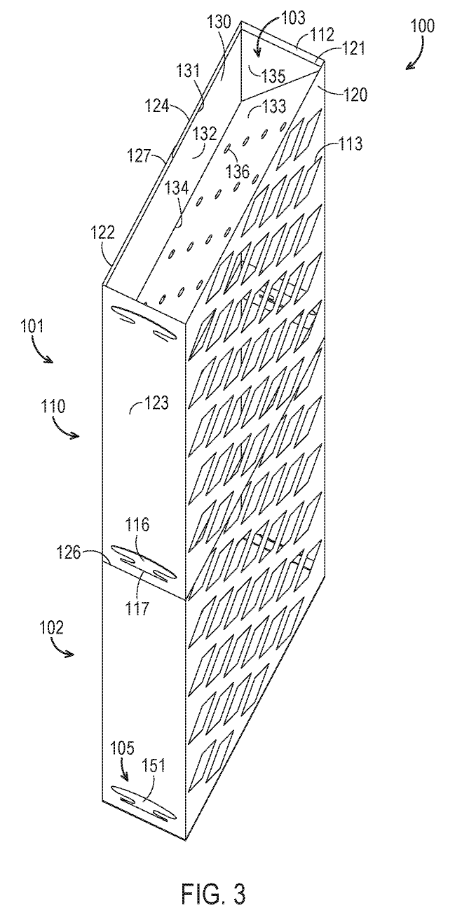

As shown in FIG. 3, water dispenser 103 may be selectively placed inside cavity 112 via enclosure top opening 127. As apparent from FIGS. 1 and 3, water dispenser 103 is disposed proximal to enclosure top opening 127 above growth media 192 contained in cavity 112 when water dispenser 103 is selectively inserted through enclosure top opening 127 into cavity 112. As further apparent from FIG. 3, water dispenser 103 is disposed proximal to rear wall 122 when water dispenser 103 is selectively inserted through enclosure top opening 127 into cavity 112.

Water dispenser 103 being disposed above growth media 192 enables water contained in water dispenser 103 to hydrate growth media 192 via the force of gravity. As shown in FIG. 1, water dispenser 103 being disposed proximal to rear wall 122 causes water dispenser 103 to be visually obscured by the growth media 192 contained in cavity 112 when the enclosure 110 is viewed from a vantage point facing front wall 120. Water dispenser 103 is visually obscured by growth media 192 because growth media 192 is disposed between front wall 120 and a front wall 133 of water dispenser 130.

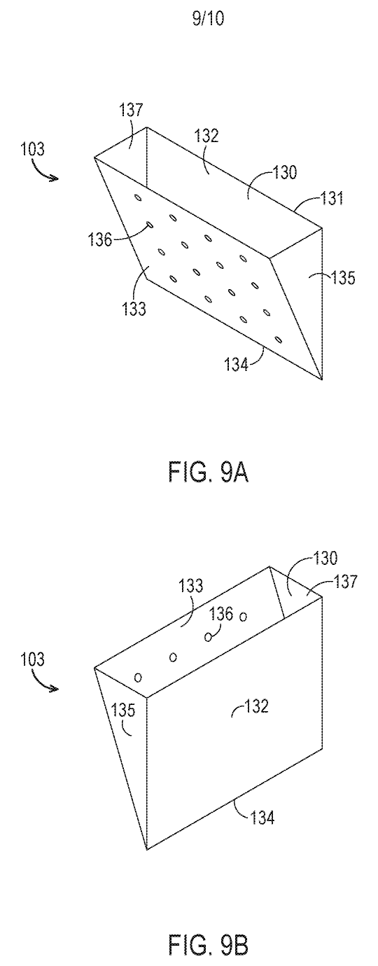

As depicted in FIGS. 9A and 9B, water dispenser 103 includes a water reservoir 130 and defines a dispenser top opening 131. Water reservoir 130 is configured to contain water. Water may be added to water reservoir 130 via dispenser top opening 131 in fluid communication with water reservoir 130.

FIGS. 9A and 9B show that water reservoir 130 has a tapered profile. The tapered profile of water reservoir 130 is defined by walls of water reservoir 130. As shown in FIGS. 9A and 9B, water dispenser 130 includes a rear wall 132, a front wall 133, a bottom edge 134, a first sidewall 135, and a second sidewall 137. Front wall 133 is disposed opposite rear wall 132 and bottom edge 134 is disposed opposite dispenser top opening 131.

The tapered profile of water dispenser 130 results from depth dimensions that decrease from top opening 131 to bottom edge 134. For example, with reference to FIGS. 9A and 9B, a top depth dimension between rear wall 132 and front wall 133 at dispenser top opening 131 is larger than a parallel bottom depth dimension between rear wall 132 and front wall 133 at bottom edge 134. The bottom depth dimension being smaller than the top depth dimension causes a front wall 133 to taper towards bottom edge 134. Expressed another way, front wall 133 extends at a vertical angle from dispenser top opening 131 to bottom edge 134.

FIGS. 9A and 9B demonstrate that front wall 133 defines water outlets 136. Water outlets 136 are in fluid communication with water reservoir 130. Water contained in water reservoir 130 drains through water outlets 136 onto growth media 192.

Significantly, water contained in water reservoir 130 drains through water outlets 136 onto growth media 192 at a selected flow rate. The selected flow rate is selected to continuously water growth media 192 over an extended time via relatively slow drips. Water outlets 136 are configured to drain water in water reservoir 130 at the selected flow rate by their size, shape, and number. The effective opening area defined by the plurality of water outlets 136 and resulting hydrodynamic resistance of water outlets 136 causes water to form droplets when passing through water outlets 136 and to accordingly flow out of water reservoir 130 at a relatively slow rate.

### Hanger

As shown in FIG. 1, hanger 104 is configured to secure enclosure 110 to support surface 190. Hanger 104 extends through mounting opening 118 defined in rear wall 122 of enclosure 110. Hanger 104 further extends into and secures to support surface 190.

Hanger 104 is an optional feature and is not included in all examples of the moss poles described herein. In some examples, a user provides his or her own hanger or mounting hardware, such as a nail, screw, or bolt. In some instances, the enclosure mounts to a rod or other structure that fits through a mounting opening defined in the enclosure. In some examples, the enclosure mounts to a support surface with a hook-and-loop fastener, a magnet, and/or an adhesive.

### Floor Member

Floor member 105 functions to selectively cover bottom opening 128 of enclosure 110. Covering bottom opening 128 of enclosure 110 maintains growth media 192 within cavity 112 and more effectively retains moisture within growth media 192.

As demonstrated in FIG. 4, floor member 105 is configured to selectively attach to lateral walls 121 and 123 to cover bottom opening 128. As shown in FIGS. 4 and 8, floor member 105 includes a floor 150 and floor connector members 151. Floor connector members 151 are complementarily configured with connector openings 117. Floor member 105 selectively attaches to lateral walls 121 and 123 by inserting floor connector members 151 into connector openings 117 defined in lateral walls 121 and 123.

When a user desires to modularly attach a second enclosure to enclosure 110, floor member 105 is selectively removed from enclosure 110. The second enclosure defined by second sheet material 102 is connected to sheet material 101 via connector members of second sheet material 102 inserting into connector openings 117 of sheet material 101. Floor member 105 may then selectively attach to a bottom opening of the enclosure defined by second sheet material 102.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A moss pole comprising:
a sheet material defining:
fold lines about which the sheet material is folded into an enclosure with walls surrounding a cavity configured to contain growth media;
access openings providing access to the cavity through the walls for a plant supported on the enclosure;
an anchor member extending from a first lateral end of the sheet material; and
an anchor opening defined proximal to a second lateral end of the sheet material opposite the first lateral end, the anchor opening being complementarily configured with the anchor member to receive the anchor member;
wherein the anchor opening and the anchor member cooperate to secure the first lateral end and the second lateral end together by the anchor member interlocking with the anchor opening.

2. The moss pole of claim 1, wherein the sheet material has a prismatic shape when folded about the fold lines to form the enclosure.

3. The moss pole of claim 1, wherein the sheet material comprises cardboard, wood, or plastic.

4. The moss pole of claim 1, wherein:
the walls include a rear wall configured to face a support surface when the enclosure is selectively mounted to the support surface; and
the rear wall has a flat outer surface configured to be positioned flat against the support surface.

5. The moss pole of claim 4, wherein the rear wall defines a mounting opening through which a hanger may extend to secure the enclosure to the support surface.

6. The moss pole of claim 4, further comprising a hanger configured to secure the enclosure to the support surface by extending through the rear wall and into the support surface.

7. The moss pole of claim 4, wherein the anchor member and the anchor opening are disposed on the rear wall when the anchor member interlocks with the anchor opening.

8. The moss pole of claim 1, wherein:
the sheet material includes:
a top end; and
a bottom end opposite the top end;
the sheet material further defines:
a connector member disposed proximal to the top end of the sheet material; and
a connector opening disposed proximal to the bottom end of the sheet material; and
the connector member is complementarily configured with the connector opening.

9. The moss pole of claim 8, wherein:
the sheet material defines a first sheet material;
the moss pole further comprises a second sheet material configured identically to the first sheet material; and
the first sheet material is configured to selectively couple to the second sheet material by selectively inserting the connector member of the first sheet material into the connector opening of the second sheet material to interlock the connector member of the first sheet material to the connector opening of the second sheet material.

10. The moss pole of claim 8, wherein:
the walls include:
a first lateral wall oriented transverse to a support surface when the enclosure is selectively mounted to the support surface; and
a second lateral wall disposed on an opposite side of the enclosure than the first lateral wall and oriented transverse to the support surface when the enclosure is selectively mounted to the support surface;
the connector member is disposed on the first lateral wall proximal to the top end; and
the connector opening is disposed on the first lateral wall proximal to the bottom end.

11. The moss pole of claim 10, wherein:
the connector member defines a first connector member;
the connector opening defines a first connector opening;
the sheet material further comprises a second connector member disposed on the second lateral wall proximal to the top end; and
the sheet material further defines a second connector opening on the second lateral wall proximal to the bottom end.

12. The moss pole of claim 1, wherein:
the walls include a front wall spaced from a support surface when the enclosure is selectively mounted to the support surface; and
the access openings are defined in the front wall.

13. The moss pole of claim 1, wherein:
the enclosure defines an enclosure top opening; and
the moss pole further comprises a water dispenser configured to selectively insert through the enclosure top opening into the cavity.

14. The moss pole of claim 13, wherein the water dispenser includes a water reservoir with a tapered profile and configured to contain water.

15. The moss pole of claim 14, wherein:
the water dispenser defines a dispenser top opening in fluid communication with the water reservoir;
the water dispenser includes:
a rear dispenser wall;
a front dispenser wall opposite the rear dispenser wall;
a bottom dispenser edge opposite the dispenser top opening;
the dispenser top opening has a top depth dimension from the rear dispenser wall to the front dispenser wall;
the bottom dispenser edge has a bottom depth dimension from the rear dispenser wall to the front dispenser wall; and
the bottom depth dimension is smaller than the top depth dimension.

16. The moss pole of claim 15, wherein the front dispenser wall extends from the dispenser top opening to the bottom dispenser edge at a vertical angle.

17. The moss pole of claim 16, wherein the front dispenser wall defines water outlets in fluid communication with the water reservoir and through which water contained in the water reservoir may drain.

18. The moss pole of claim 17, wherein the water outlets are configured to drain water at a selected flow rate.

19. The moss pole of claim 18, wherein the water dispenser is disposed proximal to the enclosure top opening above growth media contained in the cavity when the water dispenser is selectively inserted through the enclosure top opening into the cavity.

20. The moss pole of claim 19, wherein:
the walls include:
a rear wall configured to face a support surface when the enclosure is selectively mounted to the support surface;
a front wall opposite the rear wall;
the water dispenser is disposed proximal to the rear wall when selectively inserted through the enclosure top opening into the cavity;
growth media disposed in the cavity is disposed between the front wall of the enclosure and the front dispenser wall of the water dispenser; and
the water dispenser is visually obscured by the growth media contained in the cavity of the enclosure when the enclosure is viewed from a vantage point facing the front wall of the enclosure.
